(19) United States
(12) Patent Application Publication
(10) Pub. No.: US 2010/0118327 A1
(43) Pub. Date: May 13, 2010

(54) All-in-One Device with Integrated Monitor

(76) Inventors: Christopher Keith Caspar, Shelbyville, KY (US); Brian Dale Cook, Nicholasville, KY (US); Anthony Michael King, Lexington, KY (US); Joseph Wade Luciano, Lexington, KY (US); Mark Eric Miller, Versailles, KY (US); Thomas Eugene Pangburn, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/688,932

(22) Filed: Jan. 18, 2010

Related U.S. Application Data
(63) Continuation-in-part of application No. 11/778,910, filed on Jul. 17, 2007.

(51) Int. Cl. G06F 3/12

(52) U.S. Cl. 358/1.13

(57) ABSTRACT

An all-in-one device including a printer and an image capture unit disposed substantially within a housing, the image capture unit including a transparent platen and capturing an image of a media sheet positioned against the platen. The platen is substantially vertically positioned along a front portion of the housing. The image capture unit may further include a lid that is movable relative to the platen between open and closed positions, and a video monitor integrated within an outer surface of the lid and sized to serve as a monitor for a computing device.

### CROSS REFERENCES TO RELATED APPLICATION

This application is a continuation-in-part application and claims the benefit of the earlier filing date of application Ser. No. 11/778,910, filed Jul. 17, 2007, entitled “All-In-One Device with Integrated Monitor.” This application also claims the benefit of the earlier filing date of application Ser. No. 61/139,909, filed Dec. 22, 2008, entitled “Imaging Device with a Vertically Oriented Scan Unit.” The present application hereby incorporates by reference the above identified patent applications in their entirety.

### BACKGROUND

1. Field of the Invention

The present invention relates to an all-in-one device or multi-function peripheral. More particularly, the present invention relates to an all-in-one device having a scanner lid with an integrated video display or monitor for replacement of a typical desktop monitor.

2. Description of the Related Art

All-in-one devices typically utilize two or more pieces of office equipment within a single housing. For example, printers have been combined with scanner devices to provide copying function as well as digitizing of photos and documents for storage. Likewise, such printer/scanner device may also include a facsimile device with a phone line in order to receive incoming transfer of electronic documents. As multiple pieces of office equipment have been combined into a single all-in-one device, the housings, as well as the device footprint, have become larger so as to require increased surface area on desks, shelves, cabinets or other flat top surfaces utilized to position an all-in-one device.

All-in-one device designers have various goals in meeting functionality goals for these devices. For example, since all-in-one devices have increased in size with performance and functionality, one goal of designers is to decrease the footprint, or the surface area taken up with these devices. A further function which could be incorporated into an all-in-one device is manipulation of a scanned photo or drawing. For example, it may be preferable to perform redeye reduction or photo cropping prior to printing of the scanned photo or drawing through the all-in-one device. However, by decreasing the footprint of the all-in-one device, a useful video display size becomes increasing difficult to locate on the device and further increases the difficulty of a user trying to manipulate scanned photos or the like.

Currently, multi-function peripherals compete with monitors, keyboards, input devices, such as mice, as well as other peripherals and documents for desktop space. It has been a goal to increase desktop space by combining various components into a single device. Heretofore, monitors have been stand-alone components. The prior art multi-function devices have utilized small monitors to view and edit photos prior to printing. However, meaningful editing has been limited by the small screen size. A larger full-size screen would resolve this issue. A larger screen size would also allow for combined use with a CPU as a monitor for computing and watching video. Likewise, such combination would save precious desktop surface area.

### SUMMARY OF THE INVENTION

An all-in-one device including a printer comprises a housing, a scanner including a scanner lid hingeably connected to the housing, and, a video display formed in the scanner lid. The video display may possess one or more of the following characteristics. For example, the video display may be at least 12.1″ in size. The video display may have a 4:3 size ratio. The video display may alternatively have a 16:9 size ratio. The video display may occupy at least about one-quarter of the surface area of the lid. The scanner lid may be oriented substantially vertically or substantially horizontally. The video display may be a liquid crystal display.

A multi-function peripheral device comprises a housing having a printer and a scanner, the scanner has a scanner lid oriented in a substantially vertical plane, the lid having an integrated monitor opposite the scanner. The multi-function peripheral device further comprises a lid hinge connecting the housing and the scanner lid along an edge of the scanner lid, such as a substantially horizontal edge. The integrated monitor may be a liquid crystal display. The integrated monitor may have a size including at least about one-quarter of the scanner lid surface area. The multi-function device further comprises a video input connector for receiving a video signal from an external video source.

A multi-function peripheral comprises a vertically oriented housing, a printer, a scanner, a scanner lid hingedly connected to the housing and a video monitor integrally disposed on an outer surface of the scanner lid. The scanner lid and video monitor are disposed in a substantially vertical plane. The video monitor comprises a liquid crystal display. The video monitor may be sized to substantially cover a scanner bed. In addition or in the alternative, the video monitor has a size of at least one-half the scanner lid.

In accordance with another embodiment of the present invention, there is disclosed a multi-function apparatus including a printer; a housing; and a scan unit having a scan glass coupled to the housing and disposed substantially vertically thereto, the scan unit capturing an image of a media sheet disposed against the scan glass. The scan unit may substantially simultaneously capture an image of at least a majority portion of the media sheet.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an exemplary multifunction peripheral device with integrated monitor;

FIG. 2 is a perspective view of the multifunction peripheral device of FIG. 1 with a cut-away portion revealing an exemplary print mechanism;

FIG. 3 is a perspective view of the exemplary device of FIG. 1 with the monitor/scan lid opened;

FIG. 4 is a perspective view of the exemplary device of FIG. 3 with the scanner glass partially removed to show some scanner components;

FIG. 5 is a rear perspective view of the exemplary multi-function device of FIG. 1;

FIG. 6 is a perspective view of the multifunction peripheral device of FIG. 1 which further utilizes touchscreen technology;

FIG. 7 is an alternative embodiment including an automatic document feeder;

FIG. 8 is an alternative multifunction peripheral device which utilizes a horizontally positioned flat bed scanner lid;

FIG. 9 is a perspective view of the multifunction peripheral of FIG. 1 connected to a computer for use;

FIG. 10 is a block diagram of components found in the multi-function peripheral device of the present invention;

FIG. 11 is a schematic diagram of a side elevational view of a portion of a multifunction device according to an exemplary embodiment of the present invention;

FIG. 12 is a front elevational view of FIG. 13;

FIG. 13 is a side elevational view of a multifunction device according to an exemplary embodiment of the present invention; and

FIG. 14 is a rear perspective view of the multifunction device of FIG. 13.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Furthermore, and as described in subsequent paragraphs, the specific mechanical configurations illustrated in the drawings are intended to exemplify embodiments of the invention and that other alternative mechanical configurations are possible.

The term image as used herein encompasses any printed or digital form of text, graphic, or combination thereof. It should be understood that any target document or image may be scanned and manipulated, however for purpose of this description the term “image” will be used throughout. The term output as used herein encompasses output from any printing device such as color and black-and-white copiers, color and black-and-white printers, scanning device or so-called “all-in-one devices” or “multi-function peripherals” that incorporate multiple functions such as scanning, copying, and printing capabilities in one device. Such printing devices may utilize ink jet, dot matrix, dye sublimation, laser, and any other suitable print formats. The term button as used herein means any component, whether a physical component or graphic user interface icon, that is engaged to initiate output. The term ADF as used herein means auto-document feeder and may be utilized on printers, copiers, scanners, multi-function peripheral devices and other such devices utilizing automated media feeding.

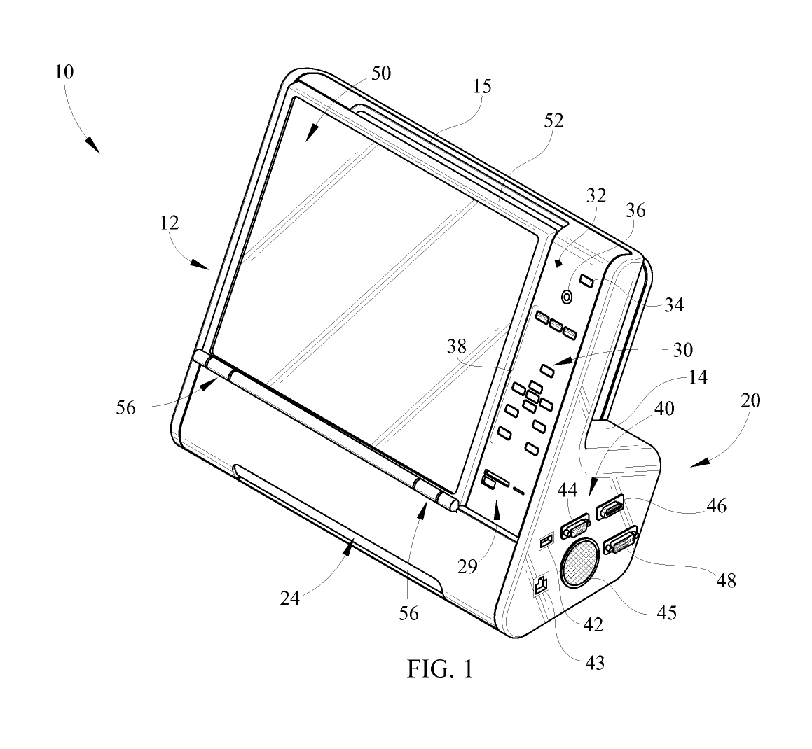

Referring now in detail to the drawings, wherein like numerals indicate like elements throughout the several views, there are shown in FIGS. 1-10 various aspects of a multi-function peripheral device with integral monitor 10. The multi-function peripheral device 10 utilizes a monitor 50 which is appropriate for use as a primary viewing device when connected to a video source signal and also allows for viewing of menu selections for operation of the multi-function peripheral device 10. Further, the monitor 50 may be used in combination with controls and software on the device 10 to manipulate scanned images or images stored on flash memory devices and read by the reader station Nevertheless, it should be understood that it is equally applicable to other machines which utilize media sheet feeding mechanisms such as copiers, fax machines, auto-document feeding scanner devices or other mechanisms utilizing such sheet feeding devices for feeding both light and heavy weight media.

Referring initially to FIG. 1, the multi-function peripheral device 10 is shown having an upper scanner portion 12 and a lower printer portion 20, packaged within a housing 14. The multi-function peripheral device 10 is shown and described herein, however one of ordinary skill in the art will understand upon reading of the instant specification that the present invention may be utilized with a stand alone printer, copier, scanner or other peripheral device which utilizes desktop space. The peripheral device 10 further comprises a control panel 30 having a plurality of buttons 38 for making command selections or correction of error conditions, and which will be described further herein.

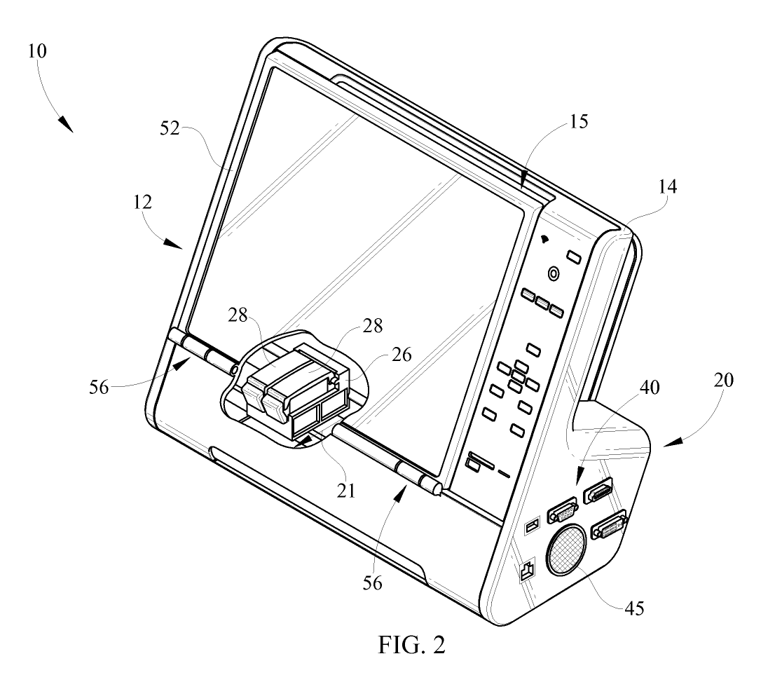

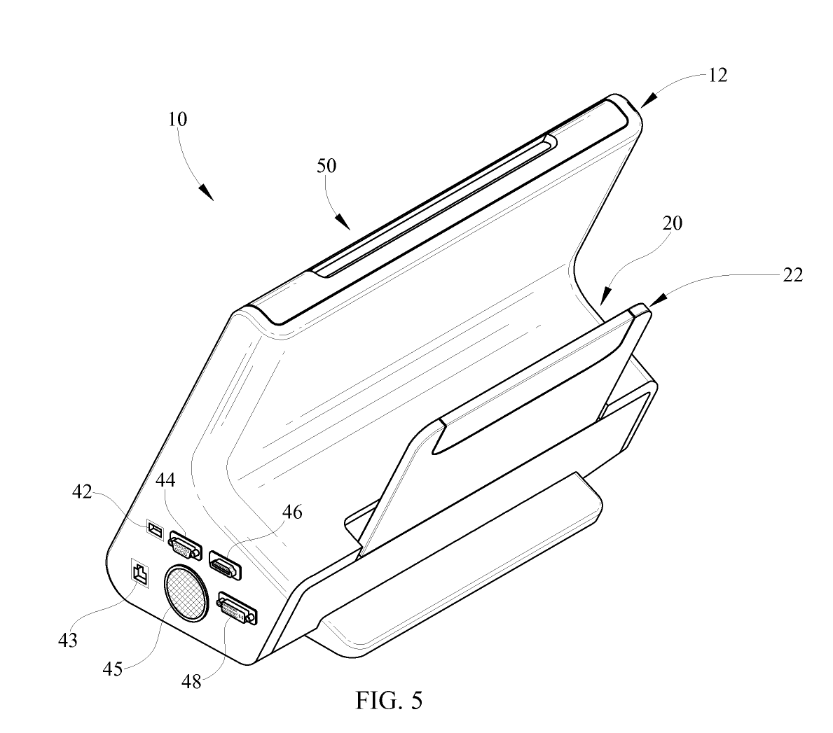

The printer portion 20 includes at least one media tray for media throughput. Extending from the rear of the printer portion 20 is an input tray 22 for retaining media prior to printing (See FIG. 5). The input tray 22 is generally vertically oriented for feeding media (not shown) into the printer portion 20. At the front of the printer portion 20 is an output area 24 for retaining media after a print process. The exemplary device does not utilize an output tray however, an output tray is within the scope of the present invention such as a telescoping tray assembly which may be slidably extended during printing or slidably retracted into a nested configuration when not in use. Alternatively, a rigid tray may be utilized. The input and output area 22, 24 of the printer portion 20 define start and end positions respectively, of a media feedpath 21 (FIG. 2 indicated by an arrow) through the printer portion 20. One skilled in the art will understand that the media feedpath 21 illustrated is an L-shaped media feedpath due to the depicted configuration. However, it is within the scope of the present invention that the C-shaped media feedpath configuration or a straight-through feedpath may be utilized. The input tray 22, or the output tray if utilized, may retain a preselected number of sheets defining a stack of media (not shown) which will vary in thickness based on the media type.

Referring now to FIGS. 1 and 2, the printer portion 20 may include various types of printing mechanisms including dye-sublimation, dot-matrix, ink jet or laser printing. For ease of description, the exemplary printer portion 20 may be an inkjet printing device although such description should not be considered limiting. The printer portion 20 of the exemplary device 10 includes various components generally described but not shown. The printer portion 20 includes a carriage 26 having a position for placement of at least one print cartridge 28. According to an exemplary embodiment, two print cartridges may be utilized wherein, by way of example, a color cartridge is utilized for photos and a black cartridge for text or other monochrome printing. As one skilled in the art will recognize, the color cartridge may include three inks, i.e., cyan, magenta and yellow inks Alternatively, in lower cost machines, a single cartridge may be utilized wherein the three inks, i.e., cyan, magenta and yellow inks are simultaneously utilized to provide the black for text printing or for photo printing. As a further alternative, a single black cartridge may be used. During advancement media moves from the input tray 22 to the output 24 along a substantially L-shaped media feedpath 21 beneath the carriage 26 and cartridges 28. As the media moves into a printing zone beneath the at least one ink cartridge 28, the media moves in a first Y-direction (north-south) along feedpath 21 and the carriage 26 and the cartridges 28 move in a second X-direction (east-west) which is transverse to the movement of the media M. During this movement, ink is selectively ejected onto the media to form an image.

Referring still to FIG. 1, the front surface of the multi-function peripheral device 10 comprises a control panel 30 for controlling the various functions and connectivities of the multi-function peripheral device 10. A device controller 80 (FIG. 10) is utilized to receive inputs and commands and signals the various components of the device 10. The device controller 80 receives commands from selections made at plurality of control buttons 38 and accordingly operates appropriate components of the device 10, such as the printer 20, scanner 12 or the components described herein. Alternatively, the device 10 may receive commands from a computer connected to the device 10. The peripheral device 10 may comprise wireless connectivity for connection to wireless networks. Wireless-Fidelity (Wi-Fi) networks use radio technologies called IEEE 802.11a, 802.11b or 802.11g to provide secure, reliable, fast wireless connectivity. A Wi-Fi network can be used to connect computers to each other, to the Internet, and to wired networks (which use IEEE 802.3 or Ethernet). Wi-Fi networks operate in the 2.4 and 5 GHz radio bands, with an 11 Mbps (802.11b) or 54 Mbps (802.11a/g) data rate or with products that contain both bands (dual band). Likewise, Wi-Fi network connections provide real-world performance similar to the basic 10 BaseT wired Ethernet networks. In the exemplary embodiment, the wireless connectivity may operate through known standards IEEE 802.11 a/b/g. This allows the peripheral device 10 to be wirelessly connected to the network. Although such structure is not shown, one skilled in the art will understand such implementation with the device 10. At the upper left corner of the control panel 30 is a Wi-Fi indicator 32 which notifies a user that the Wi-Fi connectivity is enabled allowing the peripheral device 10 to connect to a wireless network.

The device 10 may also utilize Bluetooth technology to communicate with other peripheral devices, such as, for example, handheld digital cameras (not shown) in order to, for example, transfer pictures from the camera to the device 10 for printing on the printer portion 20. Bluetooth wireless technology is a short-range communications technology intended to replace the cables connecting portable and/or fixed devices while maintaining high levels of security. The Bluetooth specification defines a uniform structure for a wide range of devices to connect and communicate with each other. Bluetooth enabled electronic devices connect and communicate wirelessly through short-range, ad hoc networks, which are established dynamically and automatically as Bluetooth enabled devices enter and leave radio proximity. Bluetooth enabled devices use the inquiry procedure to discover nearby devices, or to be discovered by devices in their locality. The inquiry procedure is asymmetrical. A Bluetooth enabled device that tries to find other nearby devices is known as an inquiring device and actively sends inquiry requests. Bluetooth enabled devices that are available to be found are known as discoverable devices and listen for these inquiry requests and send responses. The device 10 may comprise, for example, a blue light indicating the Bluetooth communication system is either on or off. Alternatively, the indicator 32 may change to a blue color indicating the Bluetooth communication system is operating.

Adjacent the indicator 32 at the top of the control panel 30 is a power indicator 34. The power indicator 34 may notify a user that the power on the peripheral device is either connected, turned on or both. An LED light or other such known luminaire may be utilized to as the indicator. Further, the LED may flash or have preselected illumination patterns or sequences to indicate different conditions, such as, for example an empty media input tray, printing error or the like.

Beneath the Wi-Fi indicator 32 and the power indicator 34 is a camera 36. A lens structure is positioned within the control panel 30 which may capture either video or still images of a user sitting at the peripheral 10. The camera 36 may be utilized with software to make video clips, perform video conferencing, or take digital photographs.

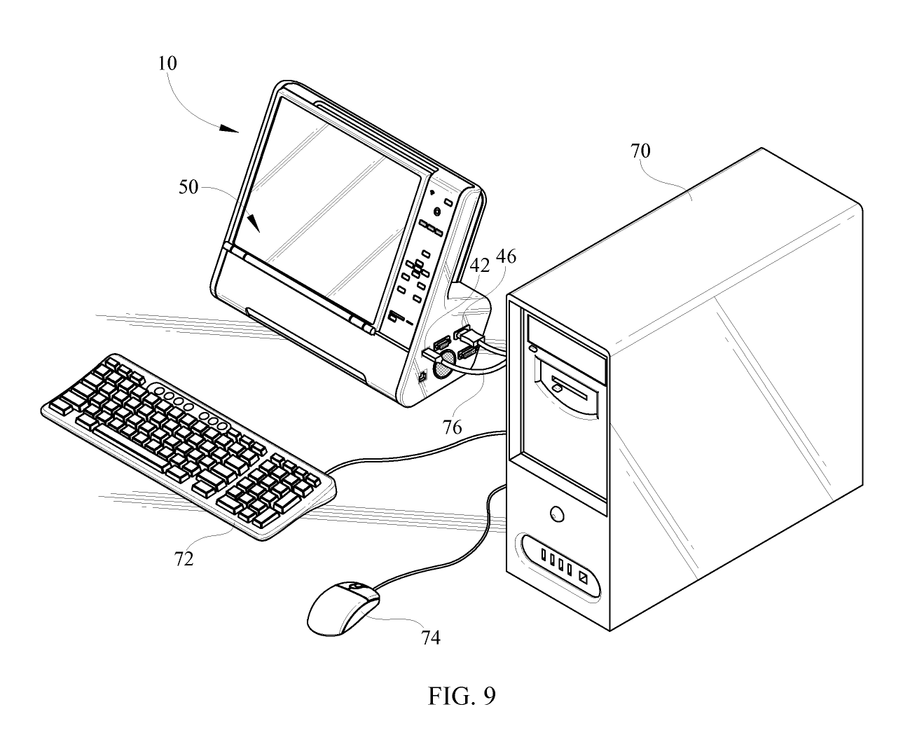

Still referring to FIG. 1, beneath the camera 36 is a memory card reader station 29 and a plurality of control buttons 38. The memory card reader station 29 is depicted adjacent the control panel 11. The memory card reader 29 receives various types of memory cards which may store picture files for printing or other manipulation by the device 10. These include USB flash drives, Secure Digital (SD) cards, micro SD cards, Sony® memory stick devices and the like. The media card reader station 29 receives various media types having images located thereon. The images may be displayed on peripheral device monitor 50 and may subsequently be edited or formatted as desired and printed through printer portion 20 or saved to memory card at reader 29 or to a computer 70 (FIG. 9) or to a network storage device (not shown).

Disposed on a side surface of the peripheral device 10 are a plurality of connective structures 40 which may be connected to a controller 80 (FIG. 10) on-board the device 10. The structures 40 include a universal serial bus (USB) connector 42. USB is a serial bus standard to interface peripheral devices, such as the peripheral device 10, and is designed to allow peripherals to be connected using a single standardized interface socket. USB also improves plug-and-play capabilities by allowing devices to be connected and disconnected without rebooting the computer (hot swapping). Other convenient features include powering low-consumption devices without the need for an external power supply and allowing some devices to be used without requiring individual device drivers to be installed. In the embodiment depicted, the peripheral 10 may be connected to a CPU 70 (FIG. 9) or USB hub for utilizing the printing and scanning functions of the multi-function peripheral device 10.

Adjacent the USB connector 42 are three video connectors. The first video connector is an analog connector 44 which is an analog video connector for receiving analog signals from a video card of a CPU. The analog connector 44 may be a video graphics array (VGA) connector, super video graphics array (SVGA) or other such connector for transmitting video signals to the monitor 50.

Adjacent the analog connector 44 is a high definition multimedia interface (HDMI) connector 46. The HDMI connector 46, as known to one skilled in the art, transfers a digital high definition signal as well as digital audio signal to and from an audio/video source. Since a single cable is utilized to carry both audio and video signal, the wire clutter between components is reduced, which is aesthetically pleasing.

Beneath the HDMI connector 46 is a digital visual interface (DVI) connector 48 which is also a digital video signal connector and functions as a conduit for high definition signals from a video source, in this case such as a video card, generally indicated as within the CPU 70 (FIG. 9). The DVI standard is designed to maximize the visual quality of digital display devices and is designed primarily for carrying uncompressed digital video data to a display. However, unlike the HDMI connector 46, the DVI connector 48 does not transmit audio signals in combination with the video signal. The various connectors are arranged in exemplary manner however, alternative connectors may be utilized in a fashion which is suitable for the intended use and therefore are well within the scope of the present invention.

Beneath the USB connector is an Ethernet or local area network (LAN) connector 43, commonly known as a RJ-45 connector. The term Ethernet refers to the family of local-area network (LAN) products covered by the IEEE 802.3 standard. Three data rates are currently defined for operation over optical fiber and twisted-pair cables: 10 Mbps—10 Base-T Ethernet, 100 Mbps—Fast Ethernet and 1000 Mbps—Gigabit Ethernet. The Ethernet connector 43 may be a 10/100/1000 Ethernet connection utilized to connect the peripheral device 10 to a LAN which allows access to the printing functionality of the device 10 over a network infrastructure. Such connector also allows access to network storage devices for saving images scanned by the scanner portion 12 or obtained by the card reader 29.

Adjacent the connector 40 is a speaker 45. The speaker 45 transmits audio from a received audio signal and is typically utilized to listen to music, audio files, or during playback of video through the peripheral device 10. The speaker 45 is shown on one side of the device 10, and a second speaker (not shown) is disposed on the opposite side in the exemplary embodiment. However, the at least one speaker 45 may be located at various positions on the device 10.

Referring still to FIGS. 1 and 2, adjacent the control panel 30, the peripheral device 10 comprises a monitor 50 which also functions as a pivotal scanner lid. The exemplary monitor 50 maybe a liquid crystal display (LCD) although alternative thin screen displays may be utilized such as SED, OLED, plasma or other such thin or flat panel display technology. A surface-conduction electron-emitter display (SED) is a flat panel display technology that uses surface conduction electron emitters for every individual display pixel. The surface conduction emitter emits electrons that excite a phosphor coating on the display panel, the same basic concept found in traditional cathode ray tube (CRT) televisions. This means that SEDs use small cathode ray tubes behind every single pixel (instead of one tube for the whole display) and can combine the slim form factor of LCDs and plasma displays with the superior viewing angles, contrast, black levels, color definition and pixel response time of CRTs. SEDs are also believed to consume less power than LCD displays. The surface conduction electron emitter apparatus consists of a thin slit across which electrons tunnel when excited by moderate voltages (tens of volts). When the electrons cross electric poles across the thin slit, some are scattered at the receiving pole and are accelerated toward the display surface by a large voltage gradient (tens of thousands of volts) between the display panel and the surface conduction electron emitter apparatus. An organic light-emitting diode (OLED) is any light-emitting diode (LED) whose emissive electroluminescent layer comprises a film of organic compounds. The layer usually contains a polymer substance that allows suitable organic compounds to be deposited. They are deposited in rows and columns onto a flat carrier by a simple “printing” process. The resulting matrix of pixels can emit light of different colors. Such systems can be used in television screens, computer displays, portable system screens, advertising, information and indication. OLEDs can also be used in light sources for general space illumination, and large area light-emitting elements. OLEDs typically emit less light per area than inorganic solid-state based LEDs which are usually designed for use as point light sources. A great benefit of OLED displays over traditional liquid crystal displays (LCDs) is that OLEDs do not require a backlight to function. Thus they draw far less power and, when powered from a battery, can operate longer on the same charge. OLED-based display devices also can be more effectively manufactured than LCDs and plasma displays.

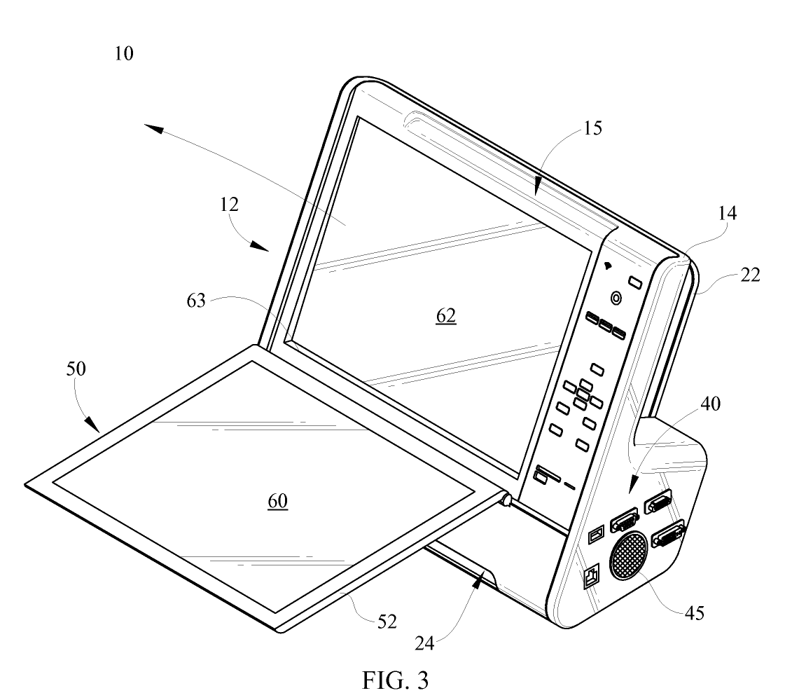

A surrounding bezel 52 frames the monitor 50. In order to pivotally connect the monitor to the housing 14, a hinge 56 is disposed between the bezel 52 and the housing 14 of the peripheral device 10. The hinge 56 allows the monitor 50 to be positioned in a normally closed position as shown in FIG. 1 or opened to the position shown in FIG. 3. The monitor 50 is positioned for viewing in the closed position of FIG. 1. The opened position allows placement of media on the scanner glass or platen 62 for scanning of the target image such as documents, photos, drawings or the like.

The monitor 50 is sized to be utilized as a replacement for a desktop monitor. As a result, a large amount of desktop is reclaimed for use rather than utilized by computing components. The exemplary monitor 50 utilizes at least one-quarter of the surface area of the scanner lid and is at least a 12.1″ screen, a size often utilized for notebook or laptop computers. The monitor 50 may be sized for a larger screen and may be formatted in 4:3 size ratio, 16:9 wide-screen size ratio, or other usable format suitable for computing as well as viewing photos and video playback. Such size is not merely a size change but comprises at least one novel function of allowing the peripheral device be connected to a computer for use as a computing monitor as well as viewing scanned images or images from memory cards for editing prior to printing, thus increasing usable desktop space for a user.

The exemplary monitor 50 displays an image captured from the scanning portion 12, the memory station 29 or a video signal from the CPU 70 (FIG. 9). The monitor 50 receives the video signal via the VGA connector 44, HDMI connector 46 or DVI connector 48. Such connectivity allows the monitor 50 to display a video output from a computer video card (not shown). Thus, the peripheral device 10 acts as a monitor, printer and scanner. The use of the device 10 for these three functions also saves desktop space for a user. The monitor 50 is typically a stand alone structure through which users interact with a computer 70 (FIG. 9). Thus, the use of the combination monitor and printing/scanning peripheral saves precious desktop space which users typically desire.

Referring to FIG. 3, the monitor/scanner lid 50 is disposed in the open position revealing the scanner portion 12. Disposed on the housing rear of the monitor 50 is a reference material 60. The reference material 60 blocks light from interfering with the scanner 12 during a scanning function when the monitor/scanner lid 50 is disposed in a closed position. Opposite the monitor/lid 50 is a platen 62 which is defined by a transparent material such as glass or plastic. The platen 62 is generally disposed in a partially vertical plane substantially parallel to the monitor/lid 50 in the closed position of FIG. 1. In order to aid a user in correct placement of media on the scanner bed platen 62, the housing 14 surrounding the housing 14 surrounding the platen 62 may be tapered away from the platen 62 to define a shoulder 63 along a lower horizontal edge of the platen 62. The target media may be positioned on the shoulder 63 and provides a support surface on which the target media may be seated for correct positioning to scan. Alternatively, instead of tapering the housing 14, the platen 62 may be tapered inwardly from the surface of the housing 14 so as to provide the shoulder 63 wherein the target media may be seated. The scanner platen 62 is useful for photos or other such media not suitable for automatic document feed scanning, although it should be understood that any media may be utilized with the present invention. The housing 14 also comprises a notched area defining a handle 15 wherein a user may position a hand for movement of the monitor/lid 50.

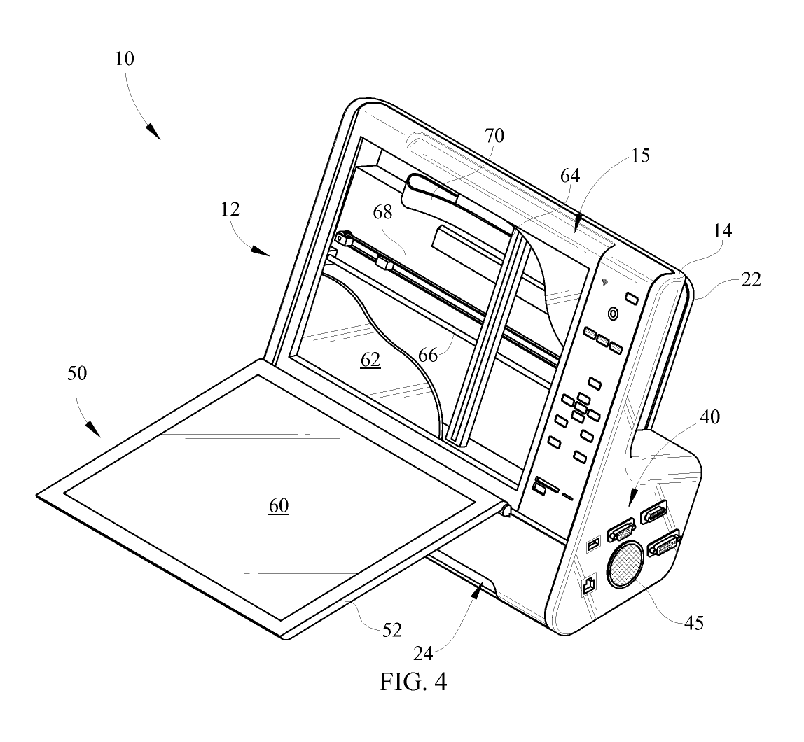

Referring now to FIG. 4, the platen 62 is partially cut-away to depict various internal components of the scanner portion 12. A scan bar or scan head 64 is slideably connected to a guide bar or rail 66. A drive mechanism 68 is connected to the scan bar 64 in order to move the scan bar 64 along the guide bar 66 in a scanning direction. A control ribbon cable 70 provides power to the scan bar 64 and allows transfer of optical signals from the scan bar 64 to the controller 80 (FIG. 10) within the peripheral device 10. The controller 80 also provides signals to a motor to move the scan bar 64 via the transmission 68. The exemplary scan bar 64 acquires an image from a target image or object by successively scanning line images of the object being scanned. Accordingly, the transmission 68 moves the scan bar 64 along the guide bar 66 obtaining line images of the target image. The scan bar 64, guide bar 66, drive mechanism 68 and ribbon or data connector 70 are all placed beneath the platen or scan glass 62 upon which the target image or object is disposed during scanning

The scan bar 64 utilizes image acquiring components to capture each scan line during the sweeping motion beneath the platen 62. Such image acquiring structure is not shown but may include a charge coupled device (CCD) or a contact image sensor (CIS). In the case of a CCD linear photo sensor array, an optical system is included within the scan bar 64 to focus the successive line images of the target object onto the CCD. The optical system (not shown) may include a lens as well as at least one mirror for bending the light path to the CCD photo sensor array. Alternatively, a CIS photo sensor array offers a reduced size and may be preferred in order to reduce the footprint of the multi-function peripheral device 10. Contrary to the CCD type scanning system, a CIS type scanning system does not require the optical system.

In operation, a target image or document is located on the platen 62 and may be positioned at one of the corners, such as one of the lower corners, of the platen 62 so that the target image is properly oriented and located toward a scan bar 64 home position. Once the target image is properly positioned, the lid 50 is closed so that the reference material 60 is positioned over the target image and platen 62 to inhibit ambient light interference with the light source (not shown) for scanning The scan bar 64 is moveable in the direction of the guide bar 66 as is well known in the art for repeatedly producing a representative image of the target image, such as a photograph, a page of text, or other such image.

Referring now to FIG. 5, a rear perspective view of the multi-function peripheral device 10 is depicted. The rear perspective view shows the input media tray 22 extending from the housing of the device 10. The media tray 22 defines the beginning of the substantially L-shaped media path 21 (FIG. 2) extending from the input tray 22 through the device 10 to the output 24. The input tray 22 may be rigidly connected to the housing 14 or it may be foldable or slidably nested within a base area where the tray 22 connects to housing 14.

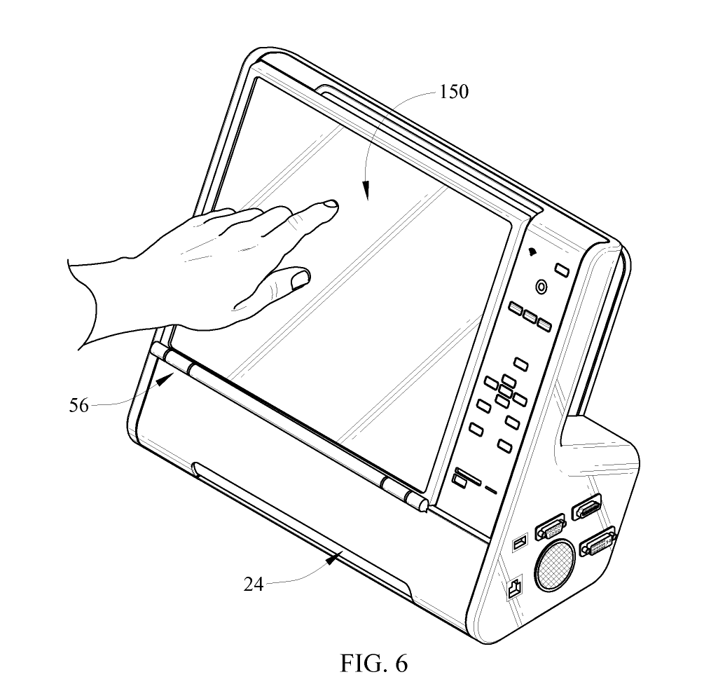

Referring now to FIG. 6, an alternative monitor 150 is depicted within the multi-function peripheral device 10. The monitor 150 is a touch-screen device as is indicated by the user's hand touching the screen. The touch-screen monitor 150 may be utilized to make inputs into the peripheral 10 as opposed to or in combination with a mouse and/or keyboard (FIG. 9). The touch-screen monitor 150 operates by utilizing at least one screen overlay which receives a signal when a user touches the monitor 150. There are at least three basic systems that are used to recognize a user's touch: resistive, capacitive and surface acoustic wave. The resistive system consists of a normal glass panel that is covered with a conductive and a resistive metallic layer. These two layers may be held apart by spacers, and a scratch-resistant layer is placed on top of the assembly. An electrical current runs through the two layers while the monitor is operational. When a user touches the screen, the two layers make contact at the location of the input force. The change in the electrical field is noted and the coordinates of the point of contact are calculated by the computer. Once the coordinates are known, a driver translates the touch into an input that the operating system can understand, much as a computer mouse driver translates a mouse's movements.

In the capacitive system, a layer that stores electrical charge is placed on the glass panel of the monitor. When a user touches the monitor with his or her finger, some of the charge is transferred to the user, so the charge on the capacitive layer decreases. This decrease is measured in circuits located at each corner of the monitor. The computer calculates, from the relative differences in charge at each corner, exactly where the touch event took place and then relays that information to the touchscreen driver software. One advantage that the capacitive system has over the resistive system is that it transmits almost 90 percent of the light from the monitor, whereas the resistive system only transmits about 75 percent. This gives the capacitive system a clearer picture than the resistive system.

On the monitor of a surface acoustic wave system, two transducers (one receiving and one sending) are placed along the x and y axes of the monitor's glass plate. Reflectors are placed on the glass which reflects an electrical signal sent from one transducer to the other. The receiving transducer is able to tell if the wave has been disturbed by a touch event at any instant, and can locate it accordingly. The wave setup has no metallic layers on the screen, allowing for 100-percent light throughput and outstanding image clarity. This makes the surface acoustic wave system best for displaying detailed graphics (both other systems have significant degradation in clarity).

Another area in which the touch systems differ is in which stimuli will register as a touch event. A resistive system registers a touch as long as the two layers make contact, which means that it does not matter if you touch it with your finger or for example a rubber eraser on the end of a pencil. A capacitive system, on the other hand, must have a conductive input, usually your finger, in order to register a touch. The surface acoustic wave system works much like the resistive system, allowing a touch with almost any object, except hard and small objects like a pen tip. Further, the resistive system is the typically the least expensive, its clarity is the lowest of the three, and its layers can be damaged by sharp objects. The surface acoustic wave setup is currently and usually the most expensive.

Referring now to FIG. 7, the peripheral 10 is depicted with a further alternative structure. The peripheral device 10 includes an automatic-document feeder (ADF) scanner portion 112. The auto-document feed scanner 112 includes a housing 114 having a media input 116 and a media output 118. The media is supported by a tray 120 extending from the housing monitor of monitor 50 as the media passes through the ADF scanner 112, the media passes over a position wherein the scan bar 64 (FIG. 4) can capture a target image from the document passing therethrough. The media passing through the ADF scanner 112 is supported near the output 118 by the tray 120 until the scanning process through the ADF scanner 112 is completed and the output media is removed. The tray 120 also functions as a stationary edge alignment feature for aligning media being fed through the ADF scanner 112. The lid 50 also functions to support the media sheets being fed into the ADF scanner 112.

The ADF scanner 112 feeds and scans stacks of documents which are normally sized, e.g. letter, legal, or A4, and thus suitable for automatic feeding. The ADF scanner 112 is a C-path device with a lower media input 116 and an upper media output 118. The media positioned on the tray 120 moves into the input 116 which is the upper opening defined in the ADF 112. As the media is input through the opening 116, the media moves over a window (not shown) within the ADF 112. Beneath the window is the scan bar 64 home position. As the media continues movement, the scan bar 64 successively scans as the media moves through an arcuate feedpath of about 180 degrees defining the C-shaped path. The opening for the media input 116 is larger than the media output 118 so that a plurality of documents may be disposed within the input 116. However, the openings 116, 118 may be similarly sized. Further, the ADF scanner is rigidly connected to the housing 14.

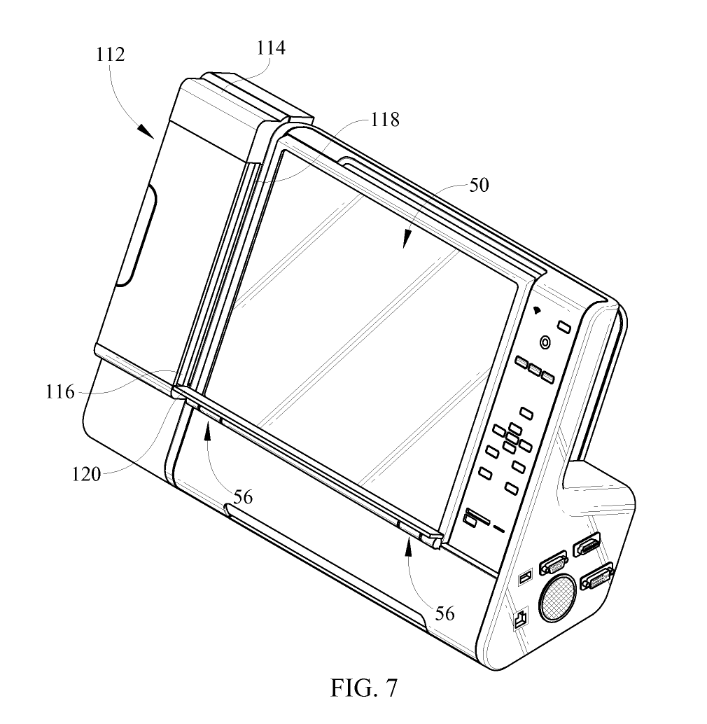

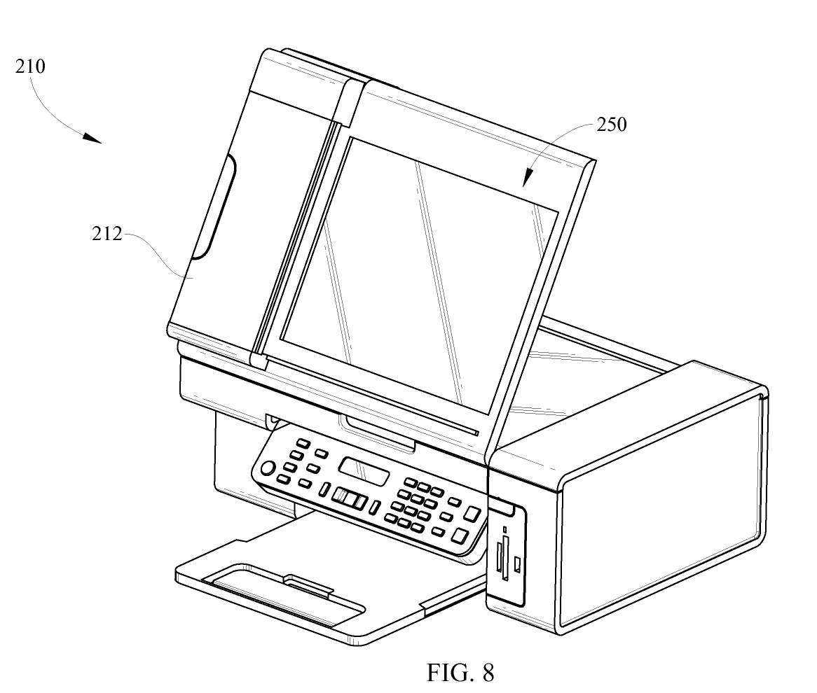

Referring now to FIG. 8, an alternative multi-function peripheral device 210 is depicted. The device 210 has a substantially horizontally oriented scanner portion 212. Accordingly, the scanner lid 250 must be tilted upwardly in order to view the monitor 50. In addition, ADF scanner 212 may be positioned horizontally for easier use with a stack of documents being scanned. Unlike the ADF scanner 112 of FIG. 7, the ADF scanner 212 is depicted as pivotable with the integrated monitor/lid 250. The ADF scanner 212 may be rigidly connected or pivotable.

Referring now to FIG. 9, the multi-function peripheral device 10 is depicted as connected to the central processing unit (CPU) 70, a keyboard 72 and mouse 74. The USB connector 42 is connected to the CPU 70 by an appropriate cable 76. The cable 76 provides communication between the device 10 and CPU 70 for printing and scanning functions. Likewise, the HDMI connector 46 also comprises a cable extending therefrom to the CPU 70 in order to provide audio and video signals from the CPU 70 to the multi-function peripheral device. Accordingly, the monitor 50 can display the video signal and the speakers 45 can provide the audio signal from the computer 70. As will be understood by one of skill in the art, the combination of the monitor 50 into the multi-function peripheral device 10, allows for removal of one desktop device which increases usability of a desktop for a user. Such ability is highly desirable since the cost of furniture to accommodate such office equipment is continually increasing as well as the square footage to accommodate both furniture and equipment.

Referring now to FIG. 10, a block diagram representing the multifunction peripheral device 10 is depicted. A main controller 80 is in communication with the scanner portion 12 and the printer portion 20. The scanner 12 is in communication with the controller 80 via an interface 81. In the exemplary embodiment the interface 81 is a 16-bit analog front end interface. Likewise, the printer portion 20 is in communication with the main controller 80. Specifically, the printheads 28 are depicted to be in communication with the main controller 80 for at least auto-alignment functions as well as temperature sensing of the printhead ejection system. Additionally, the memory card reader 29 is in communication with the main controller 80. The card reader 29, as previously described, may include multiple digital media connectors and may further utilize PictBridge which is a standard picture transfer protocol. The card reader 29 may be connected to the main controller 80 by at least one interface, USB host interfaces according to the exemplary embodiment. The main controller 80 may also be in communication with the speaker 45, the connectors 40 generally indicated by the video connectors 44, 46, 48, the USB connector 42 as well as the Bluetooth circuitry for wireless connectivity. Also, a fax 83 may be utilized with the multifunction peripheral 10. Such fax 83 is also depicted as being in communication with main controller 80.

A video controller 84 is also depicted as being in communication with the main controller 80. The video controller 84 may also comprise video RAM 85. Such video controller 84 is shown as being in communication with the control panel 30, which is shown to comprise both the plurality of control buttons 38 as well as the display 50. Likewise, the control panel 30 is also shown as being in communication with the main controller 80. The device 10 may further comprise flash memory 87 in communication with the controller 80 for upgrading firmware and the like.

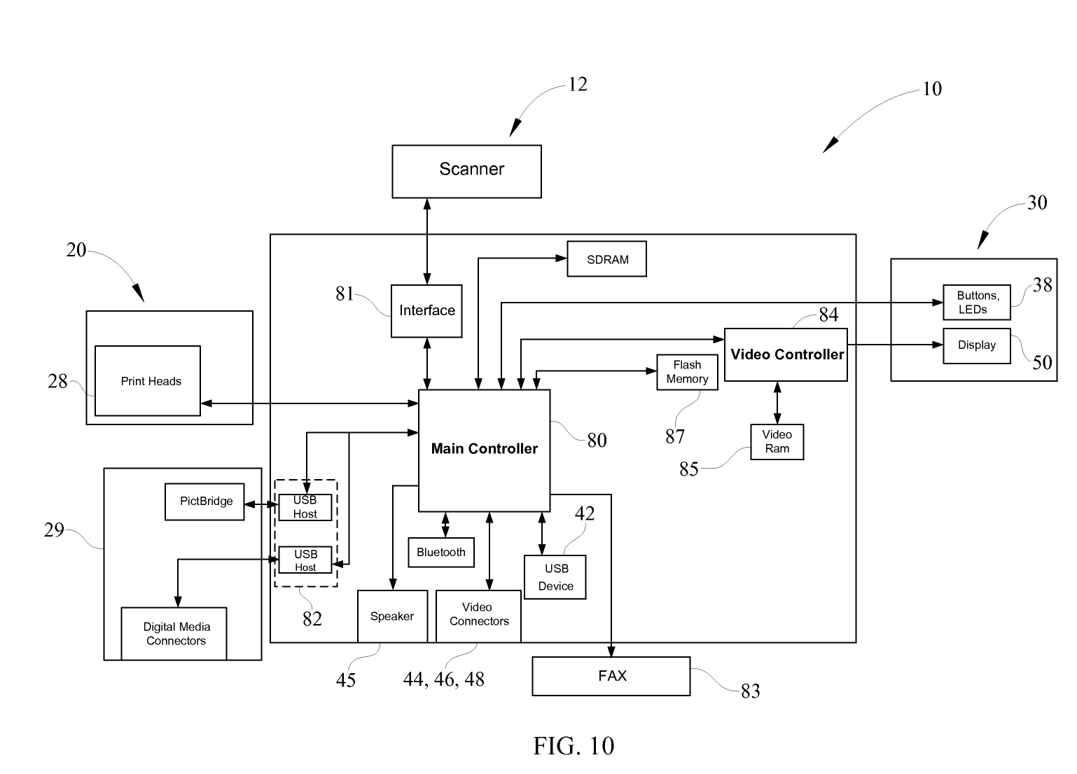

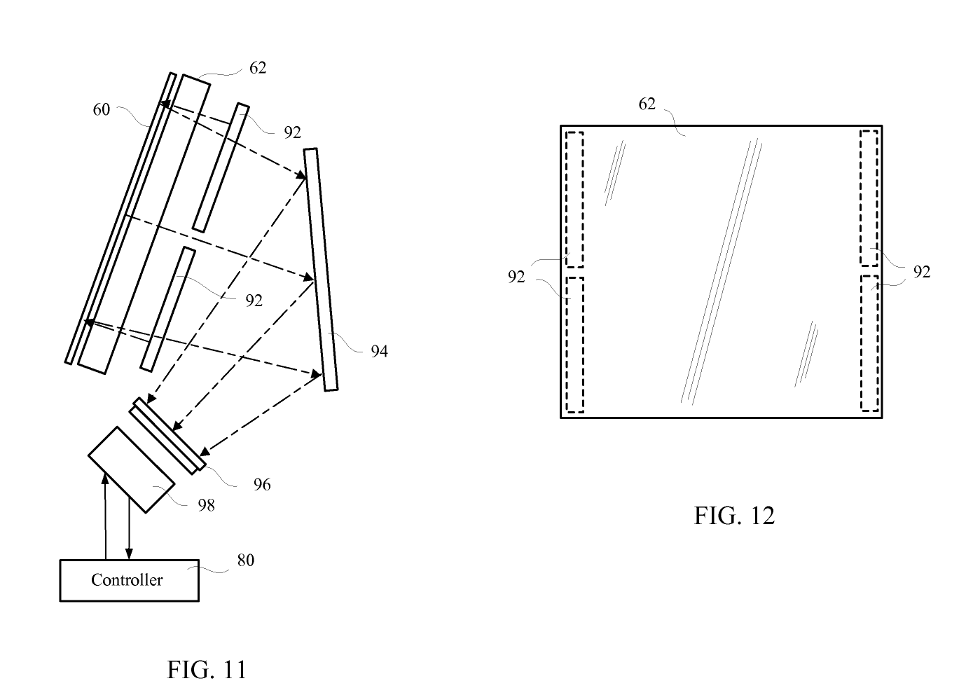

FIGS. 11-14 illustrate multifunction device 10 according to another exemplary embodiment of the present invention. Multifunction device 10 of FIGS. 11-14 may include much of the same functionality and characteristics described above with respect to FIGS. 1-10. However, instead of utilizing a scan bar 64 for capturing an image of a media sheet one or a few scan lines at a time, multifunction device 10 of FIGS. 11-14 may capture substantially the entire image the media sheet at one time. By capturing an entire image substantially simultaneously, scan bar 62 and its corresponding drive mechanism are not utilized.

FIG. 11 illustrates a portion of the image capture unit for capturing the image of media sheet 60 placed against platen 62. As described above, platen 62 may be substantially vertically oriented. In an exemplary embodiment of the present invention, platen 62 may be between about 12.5 degrees and about 32.5 degrees from the vertical, and in particular between about 17.5 degrees and about 27.5 degrees from the vertical. In one exemplary embodiment of the present invention, platen 62 is about 22.5 degrees from the vertical. One or more light assemblies 92 generate the light that is reflected from media sheet 60 for subsequent capture. A plurality of light assemblies 92 may be utilized in order to ensure that the media sheet 62 is substantially uniformly illuminated. Though FIG. 11 depicts light generated by each light assembly 92 as a single ray of light, it is understood that light assemblies 92 direct light along a relatively wide optical path. According to an exemplary embodiment, a plurality of light assemblies 92 may be arranged about and in proximity with platen 62 so that a sufficient amount of light is directed towards media sheet 60. FIG. 12 shows one arrangement of light assemblies 92 disposed behind platen 62 within housing 14. Each light assembly 92 may include a least one light source, such as an LED. Alternatively, each light assembly may include at least one set of red, green and blue LEDs. Associated with each light assembly 92 may include optics for focusing and/or filtering light generated by light assembly 92 (not shown).

With further reference to FIG. 11, a mirror 94 may be disposed behind platen 62 within housing 14. Mirror 94 is dimensioned and oriented for deflecting light reflected by media sheet 60. A lens module 96 may be disposed in optical communication with mirror 94 so that light deflected by mirror 94 is focused by lens module 96 towards optical sensor array 98. Optical sensor array 98 may include a sufficient number of pixel elements for capturing at one time a substantially entire image of media sheet 60. FIG. 11 shows the optical path of multifunction device 10 beginning with light generated by light assemblies 92 which is reflected by media sheet 60 and then deflected by mirror 94 so as to be incident on optical sensor array 98 following passage through lens module 96.

Controller 80 is communicatively coupled to optical sensor array 98 and light assemblies 92 (not shown) for controlling each during an image capture operation. In particular, controller 80 controls the activation of light assemblies 92 relative to the time period during which optical sensor array 98 captures light deflected from mirror 94.

It is understood that more or less mirrors 94 may be used in the optical path facilitating capture of an image of media sheet 60 at one time. Use of more mirrors in the optical path may reduce the volume needed for the optical path, and less mirrors may enlarge such volume. It is further understood that multifunction device 10 may include other components used in capturing an image of media sheet 60 not depicted in FIGS. 10 and 11.

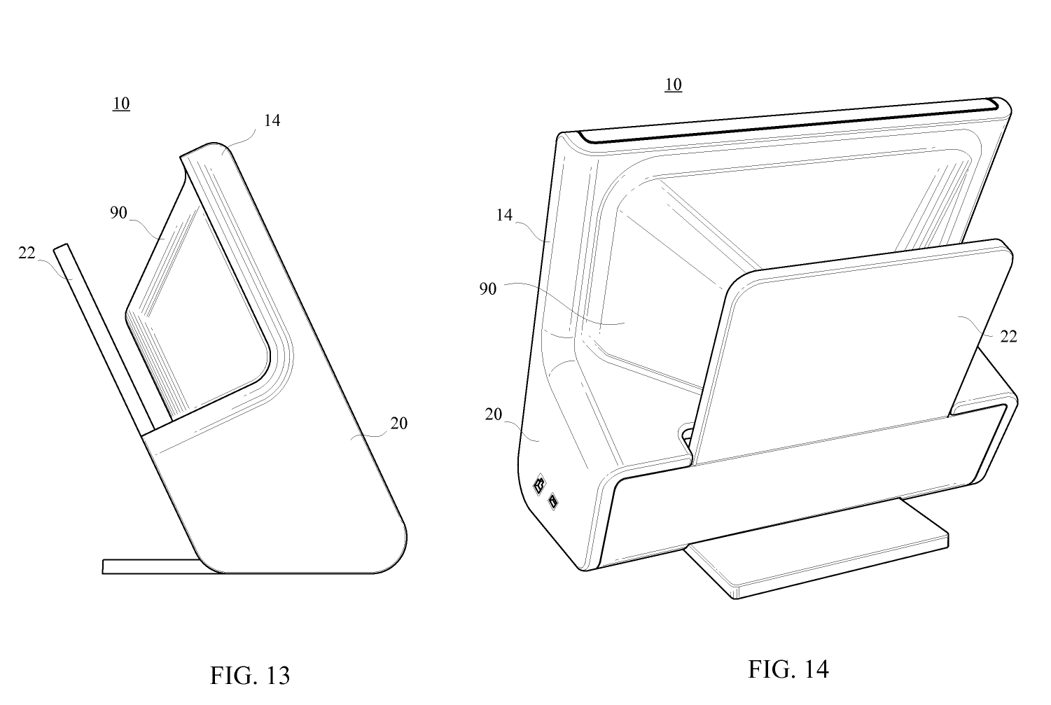

FIGS. 13 and 14 show housing 14 of multifunction device 10 including an expanded portion 90 which extends from a front portion of housing 14 towards media input tray 22. Expanded portion 90 may thus occupy a significant portion of the space between the front of housing 14 (and platen 62) and media input tray 22, substantially above lower printer portion 20. Expanded portion 90 of housing 14 may be sized to contain light assemblies 92, mirror 94, lens module 96 and optical sensor array 98 for performing image capture.

The foregoing description of structures and methods has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

1. An imaging apparatus, comprising:
a housing;
a print mechanism for printing an image on a sheet of media, including a print engine for imparting toner or ink onto the sheet of media, an input tray for holding a stack of media sheets, and a media feed mechanism for moving the sheet of media from the input tray to the print engine, the print engine and media feed mechanism being contained within the housing; and
an image capture unit at least partly contained within the housing and including a substantially vertically disposed transparent platen, the image capture unit capturing an image appearing on a media sheet when placed against the platen.

2. The imaging apparatus of claim 1, wherein the platen is oriented at an angle between about 12.5 and about 32.5 degrees from a vertical position.

3. The imaging apparatus of claim 1, wherein the media feed mechanism defines a media feed path that is substantially L-shaped.

4. The imaging apparatus of claim 3, further comprising an output area disposed at an end of the media feed path beneath the platen.

5. The imaging apparatus of claim 1, wherein the platen is position in a front portion of the housing and the input tray is positioned in a back portion of the housing, the input tray being substantially parallel to the platen.

6. The imaging apparatus of claim 1, wherein the image capture unit substantially simultaneously captures an entire image of the media sheet positioned against the platen.

7. The imaging apparatus of claim 6, wherein the image capture unit is positioned in the housing between the platen and the input tray.

8. The imaging device of claim 1, wherein the image capture unit includes a lid pivotally coupled to the housing proximally to an edge of the platen, the lid holding the media sheet in position against the platen for image capture, the lid movable between a closed position in which the lid is positioned substantially against the platen and an open position in which the lid is positioned at a distance from the platen.

9. The imaging device of claim 8, wherein the lid includes a video monitor integrated into an outwardly facing surface of the lid and sized to serve as a monitor for a computer.

10. An imaging apparatus, comprising:
a housing;
an image capture device disposed substantially within the housing, comprising a substantially transparent platen on which a sheet of media may be positioned for image capture, the platen disposed between about 12.5 degrees and 32.5 degrees from a vertical plane, and a lid coupled to the housing proximally to the platen, the lid securing the sheet of media against the platen; and
a print engine disposed within the housing for printing an image on a separate media sheet.

11. The imaging apparatus of claim 10, further comprising:
a media feeding system disposed within the housing for feeding the sheets of media from a media input area of the housing, to the print engine and subsequently to a media output area.

12. The imaging apparatus of claim 11, wherein the platen is disposed in a front portion of the housing, the media input area is positioned in a back portion of the housing and the media output area is positioned in the front portion of the housing proximally to the platen.

13. The imaging apparatus of claim 12, wherein the media output area is positioned beneath the platen.

14. The imaging apparatus of claim 12, wherein the media input area comprises an input tray positioned in the back portion of the housing substantially parallel with the platen.

15. The imaging apparatus of claim 11, wherein the media feeding system defines a media feed path having a substantially L shape.

16. The imaging apparatus of claim 10, wherein the lid is movable between a closed position in which the lid is positioned substantially against the platen and an open position in which the lid is pivoted away from the platen, and wherein the lid comprises a video monitor integrally formed therein such that the video monitor is positioned for viewing when the lid is in the closed position.

17. The imaging apparatus of claim 10, wherein the image capture device substantially simultaneously captures an entire image of the media sheet positioned against the platen.

18. The imaging apparatus of claim 17, further comprising a media input tray positioned in a back portion of the housing, wherein the platen is positioned along a front portion of the housing and the image capture device is positioned between the platen and the media input tray within the housing.

19. The imaging apparatus of claim of claim 10, wherein the platen is disposed between about 17.5 degrees and 27.5 degrees from the vertical plane.
